(19) United States
(12) Patent Application Publication
(10) Pub. No.: US 2007/0257633 A1
(43) Pub. Date: Nov. 8, 2007

(54) APPARATUS AND METHOD OF CONTROLLING SYNCHRONOUS RELUCTANCE MOTOR

(75) Inventors: June-Hee Won, Seoul (KR); Dal-Ho Cheong, Seoul (KR); Jae-Yoon Oh, Gyeonggi-Do (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/741,228

(22) Filed: Apr. 27, 2007

(30) Foreign Application Priority Data
May 4, 2006 (KR) 10-2006-0040688

(51) Int. Cl. H02P 27/04

(52) U.S. Cl. 318/801; 318/254

(57) ABSTRACT

An apparatus for driving a motor includes a rectifier which rectifies input alternating current (AC) power, a power converter which converts the rectified AC power into direct current (DC) power, an inverter which converts the DC power into AC power of a predetermined frequency that drives the motor, a position detector which detects a position of a rotor of the motor with respect to a stator of the motor by detecting a magnetic flux emanating from the rotor, and a controller which controls the inverter to control the driving of the motor according to the detected position of the rotor.

### RELATED APPLICATION

The present disclosure relates to subject matter contained in Korean Application No. 10-2006-0040688, filed on May 4, 2006, which is herein expressly incorporated by reference in its entirety.

### BACKGROUND OF THE INVENTION

1. Field of the Invention

The present invention relates to an apparatus and method of controlling a synchronous reluctance motor, and particularly to an apparatus and method of controlling a synchronous reluctance motor using a control integrated circuit (IC) and a hall sensor.

2. Description of the Background Art

FIG. 1 is a block diagram showing a configuration of a conventional apparatus for driving a synchronous reluctance motor. The conventional apparatus shown in FIG. 1 includes an alternating current (AC) power unit 11 which outputs AC power, a rectifier 12 which converts the AC power into a direct current (DC) power, a DC-DC converter 13 which increases or decreases the DC power outputted by the rectifier 12, and an inverter 14 which converts the DC power outputted by the DC-DC converter 13 into an AC power that drives a synchronous reluctance motor 15. The apparatus also includes a current sensor 16 which measures a current of the motor 15, and a microcomputer 17 which receives the current measurements from the current sensor 16, estimates a position of a rotor of the motor 15 based on the current measurements, and controls a speed of the motor 15 based on the estimated position of the rotor by outputting a pulse width modulation (PWM signal to the inverter 14 which controls the AC power outputted by the inverter 14. The microcomputer 17 stores a software program which allows it to estimate the position of the rotor from the current measurements.

One of the disadvantages of the conventional driving apparatus shown in FIG. 1 are that the current sensor 16 and microcomputer 17 are relatively expensive. Additionally, if the configuration of the motor is changed, a complicated control algorithm of the software program of the microcomputer 17 must be corrected. Further, a separate emulator is required to load a control algorithm on the microcomputer 17.

### BRIEF DESCRIPTION OF THE INVENTION

One of the features of the present invention is an economical control apparatus for controlling a synchronous reluctance motor.

To achieve at least this feature, there is provided an apparatus for driving a motor which includes a rectifier which rectifies input AC power, a power converter which converts the rectified AC power into DC power, an inverter which converts the DC power into AC power of a predetermined frequency that drives the motor, a position detector which detects a position of a rotor of the motor with respect to a stator of the motor by detecting a magnetic flux emanating from the rotor, and a controller which controls the inverter to control the driving of the motor according to the detected position of the rotor.

The position detector may include a sensing magnet, placed on a shaft on the rotor, which generates the magnetic flux, and at least one hall sensor which detects the generated flux to measure a relative location of the sensing magnet.

The sensing magnet may be fixed on the shaft such that its location is fixed with respect to the rotor. The at least one hall sensor may include a plurality of hall sensors placed at 120° intervals around the stator. The at least one hall sensor may output one of a high and a low signal, depending on whether it senses a magnetic flux from one of an N pole and an S pole of the sensing magnet.

The controller may control the inverter based on a detected position of a D-axis of the rotor. The controller may include a control integrated circuit (IC) which outputs a voltage based on a signal output by the position detector. The controller may output a 120 degree, 2-phase pulse width modulation (PWM) voltage to start the motor.

The at least one hall sensor may be placed at a center of a coil axis of the stator, and a center of a magnetic flux vector emanating from the sensing magnet may be aligned with a D-axis of the rotor. A torque of the motor may be at a maximum value when an angle between a D-axis of the rotor and a current vector of the motor is approximately 45 degrees. The motor may be a permanent magnet assisted synchronous reluctance motor.

There is also provided a method of driving a motor which includes rectifying input AC power, converting the rectified AC power into DC power, converting the DC power into AC power of a predetermined frequency, detecting a position of a rotor of the motor with respect to a stator of the motor by detecting a magnetic flux emanating from the rotor, and controlling an inverter to drive the motor according to the detected position of the rotor.

The inverter may be controlled based on a detected position of a D-axis of the rotor. A hall sensor may be placed at a center of a coil axis of the stator, and a center of a magnetic flux vector emanating from the sensing magnet may be aligned with the D-axis of the rotor.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing a configuration of a conventional apparatus for driving a synchronous reluctance motor;

FIG. 2 is a block diagram showing a configuration of an apparatus of controlling a synchronous reluctance motor according to an embodiment of the present invention;

FIG. 3 is a block diagram showing a configuration of a rotor, a hall sensor, a sensing magnet, and a controller according to an embodiment of the present invention;

FIG. 4 illustrates a flux vector diagram illustrating flux vectors of a permanent magnet assisted synchronous reluctance motor according to an embodiment of the present invention;

FIG. 5 is a cross-sectional view of a rotor, a shaft and a sensing magnet of FIG. 3;

FIG. 6 is a cross-sectional view of a rotor according to an embodiment of the present invention; and

FIG. 7 is a flow chart of a method of controlling a synchronous reluctance motor according to an embodiment of the present invention.

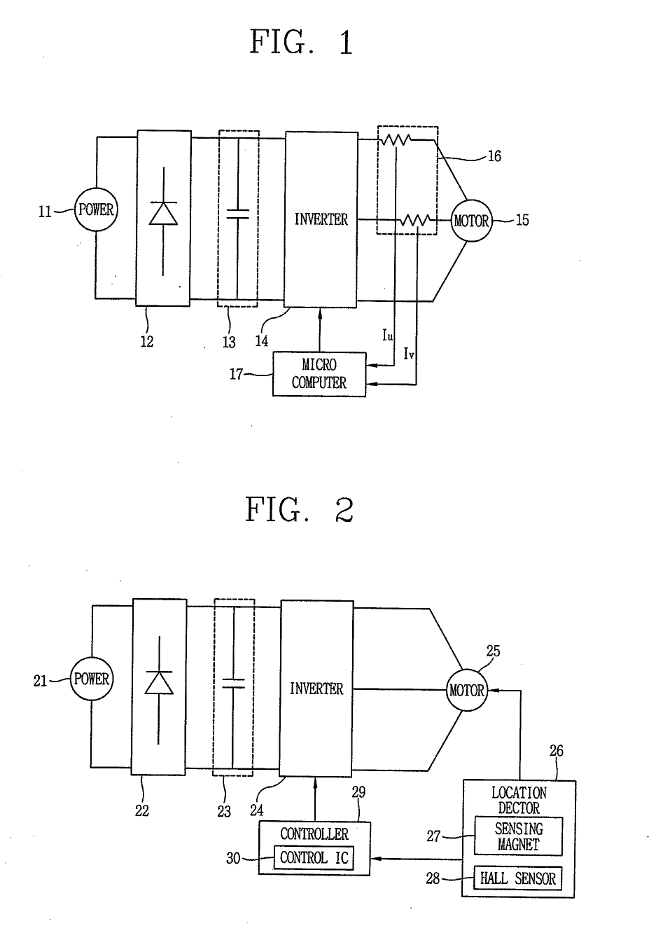

### DETAILED DESCRIPTION OF THE INVENTION

FIG. 2 illustrates an embodiment of an apparatus for controlling a synchronous reluctance motor according to the present invention. The apparatus shown in FIG. 2 includes an alternating current (AC) power unit 21 which outputs AC power, a rectifier 22 which converts AC power outputted from the AC power unit 21 into DC power, a DC-DC converter 23 which increases or decreases the DC power outputted by the rectifier 22, and an inverter 24 which converts the DC power outputted by the DC-DC converter 23 into an AC power of a predetermined frequency that drives a synchronous reluctance motor 25. The apparatus also includes a position detector 26 which detects a position of a rotor of the motor 25, and a controller 29 which drives the motor 25 by controlling the output of the inverter 24 based on the detected position of the rotor. The position detector 26 includes a sensing magnet 27 disposed on a shaft of the rotor, and a hall sensor 28 which measures a location of the sensing magnet 27 by detecting a flux.

An embodiment of the present invention will now be described in further detail. The position of the sensing magnet 27 with respect to the hall sensor 28, and thus the position of the rotor with respect to the stator, can be determined based on a correlation between a voltage and a flux, a correlation between a voltage and a current, and a correlation between a current and a D-axis of the rotor, as defined by Equations 1 and 2 below:

$$\begin{matrix}∮ \vec{E} \cdot \vec{d} l = - \frac{d Φ}{d t} & ( Equation 1 ) \\ T = \frac{3}{2} \cdot \frac{P}{2} \cdot ( {L}_{d} - {L}_{q} ) \cdot {i}_{s}^{2} \cdot \frac{sin 2 {θ}_{i}}{2} & ( Equation 2 )\end{matrix}$$

where E denotes a voltage, Φ denotes a flux, T denotes a torque, P denotes the number of poles, L_{d} and L_{q} denotes synchronous d-axis and q-axis inductances, respectively, Iₛ denotes a current, and θᵢ denotes a current angle between the D-axis of the rotor and a current.

The controller 29 may be implemented with an relatively inexpensive control IC 30, and does not require a complicated current detection process or a complicated current detecting sensor.

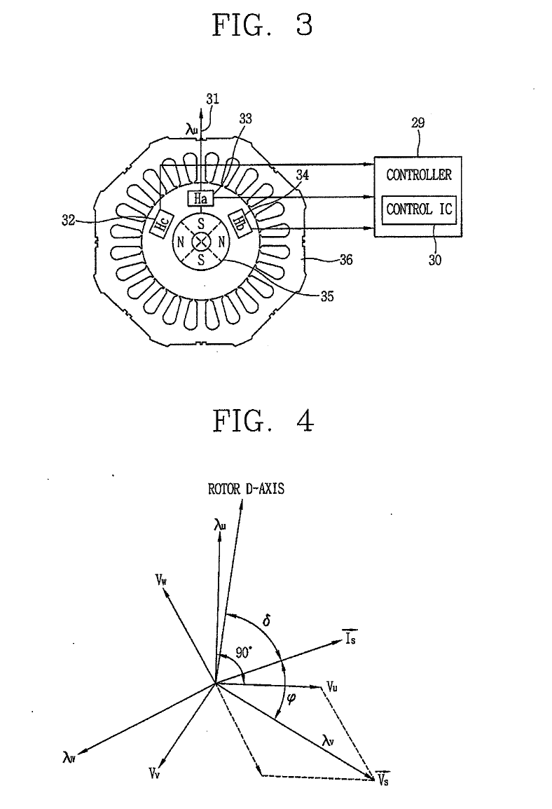

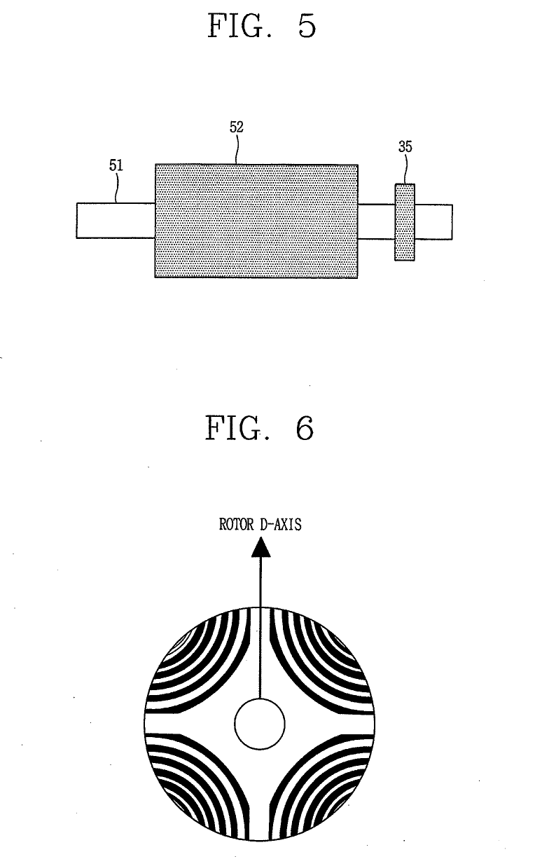

FIG. 3 is a block diagram showing a configuration of the rotor, the hall sensor, the sensing magnet and the controller according to an embodiment of the present invention, and FIG. 4 is a flux vector diagram illustrating flux vectors of a permanent magnet assisted synchronous reluctance motor according to an embodiment of the present invention.

The controller 29 outputs a 120 degree, 2-phase PWM voltage to the inverter 24 to start the motor 25. As illustrated in FIG. 3, a plurality of hall sensors Ha 33, Hb 34 and Hc 32 are fixed to a stator 36 of the motor 25, and a sensing magnet 35 is fixed to a rotor of the motor 25. When the motor 25 is started, the hall sensor Ha 33 is aligned with an S pole of the sensing magnet 35, the hall sensors Hb 34 and Hc 32 are aligned with N poles of the sensing magnet 35, and two phase voltages Vu+ and Vw− of a 3-phase voltage are applied to the motor 25.

A combined voltage vector Vs, which is the sum of the Vu and Vw voltage vectors, is shown in FIG. 4. As shown in FIG. 4, and expressed by Equation 1, the voltage vectors V_{U}, V_{V}, V_{W} differ in phase from the flux vectors λ_{U}, λ_{V}, λ_{W} w by 90 degrees. Since a power factor is relatively great at a low velocity, a phase difference φ between the combined voltage vector Vs and a corresponding current vector I_{S} is approximately 35 to 45 degrees.

As expressed in Equation 2, the torque of the synchronous reluctance motor is at a maximum value when the current angle θᵢ between the D-axis of the rotor and the current vector I_{S} is 45°.

The control IC 30 outputs a voltage based on a signal outputted by one or more hall sensors. The voltage vector applied to the motor remains constant until the D-axis of the rotor completes a substantially 60 degree rotation. If the D-axis were to lag the current vector I_{S} by 45 degrees in the rotation direction of the voltage vector, and the rotor then rotates by 60 degrees, the current angle (θᵢ) would become approximately −15°, and thus a negative torque would be generated. Thus, to prevent a negative torque from being generated, the D-axis of the rotor may be set at about 75 degrees from the current vector I_{S}.

When the rotor D-axis is placed at an angle ranging from approximately 110 to approximately 120 degrees from the combined voltage vector (Vs) in the opposite direction to the rotation direction, the synchronous reluctance motor can be stably started-up and driven.

FIG. 5 is a cross-sectional view of a rotor, a shaft, and a sensing magnet. As shown in FIG. 3, a U-phase coil axis 31 corresponds to a center of a U-phase winding, which is one of three-phases of the stator 36. As shown in FIG. 5, the sensing magnet 35 is affixed to a shaft 51 so that its location is physically fixed relative to a rotor 52.

The hall sensors Ha 33, Hb 34 and Hc 32 are physically placed at 120 degree intervals around the stator 36, and output a High or a Low signal, depending on whether they sense a flux from an N pole or an S pole of the sensing magnet 35.

FIG. 6 is a cross-sectional view of a rotor according to an embodiment of the present invention, illustrating a D-axis of the rotor.

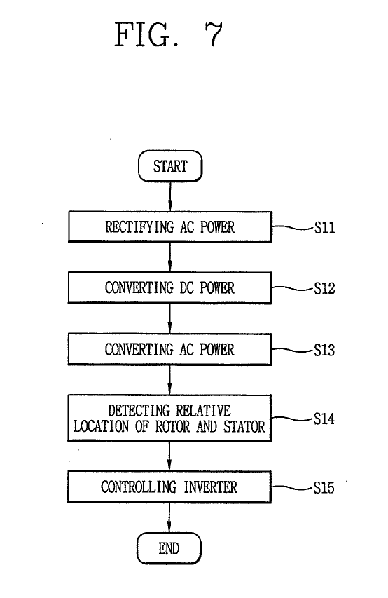

FIG. 7 shows a flowchart of a method of controlling driving of a synchronous reluctance motor according to an embodiment of the present invention. The method includes rectifying an AC power input (S11), converting the rectified AC power into DC power (S12), converting the DC power into AC power of a predetermined frequency (S13), detecting relative locations of a rotor and a stator based on a voltage and a flux (S14); and controlling an inverter in order to control the driving of the motor according to the detected relative locations (S15).

Here, the controlling of the inverter (S15) includes controlling the position of the rotor relative to the stator based on the detection of the poles of the sensing magnet by the hall sensors.

To control the inverter, the hall sensor is placed at the center of the coil axis of the stator, and the center of the magnetic flux vector emanating from the sensing magnet is aligned with the D-axis of the rotor.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. As the present invention may be embodied in several forms without departing from the spirit or essential characteristics thereof, it should also be understood that the above-described embodiments are not limited by any of the details of the foregoing description, unless otherwise specified. Rather, the above-described embodiments should be construed broadly within the spirit and scope of the present invention as defined in the appended claims. Therefore, changes may be made within the metes and bounds of the appended claims, as presently stated and as amended, without departing from the scope and spirit of the invention in its aspects.

What is claimed is:

1. An apparatus for driving a motor, comprising:
a rectifier which rectifies input alternating current (AC) power;
a power converter which converts the rectified AC power into direct current (DC) power;
an inverter which converts the DC power into AC power of a predetermined frequency to drive the motor;
a position detector which detects a position of a rotor of the motor with respect to a stator of the motor by detecting a magnetic flux emanating from the rotor; and
a controller which controls the inverter to control the driving of the motor according to the detected position of the rotor.

2. The apparatus of claim 1, wherein the position detector comprises:
a sensing magnet, placed on a shaft on the rotor, which generates the magnetic flux; and
at least one hall sensor which detects the generated flux to measure a relative location of the sensing magnet.

3. The apparatus of claim 2, wherein the sensing magnet is fixed on the shaft such that its location is fixed with respect to the rotor.

4. The apparatus of claim 2, wherein the at least one hall sensor comprises a plurality of hall sensors placed at 120° intervals around the stator.

5. The apparatus of claim 2, wherein the at least one hall sensor outputs one of a high and a low signal, depending on whether it senses a magnetic flux from one of an N pole and an S pole of the sensing magnet.

6. The apparatus of claim 2, wherein the at least one hall sensor is placed at a center of a coil axis of the stator, and a center of a magnetic flux vector emanating from the sensing magnet is aligned with a D-axis of the rotor.

7. The apparatus of claim 1, wherein the controller controls the inverter based on a detected position of a D-axis of the rotor.

8. The apparatus of claim 1, wherein the controller comprises a control integrated circuit (IC) which outputs a voltage based on a signal output by the position detector.

9. The apparatus of claim 1, wherein the controller outputs a 120 degree, 2-phase pulse width modulation (PWM) voltage to start the motor.

10. The apparatus of claim 1, wherein a torque of the motor is at a maximum value when an angle between a D-axis of the rotor and a current vector of the motor is approximately 45 degrees.

11. The apparatus of claim 1, wherein the motor is a permanent magnet assisted synchronous reluctance motor.

12. A method of driving a motor, comprising:
rectifying input alternating current (AC) power;
converting the rectified AC power into direct current (DC) power;
converting the DC power into AC power of a predetermined frequency;
detecting a position of a rotor of the motor with respect to a stator of the motor by detecting a magnetic flux emanating from the rotor; and
controlling an inverter to drive the motor according to the detected position of the rotor.

13. The method of claim 12, wherein the inverter is controlled based on a detected position of a D-axis of the rotor.

14. The method of claim 12, wherein a hall sensor is placed at a center of a coil axis of the stator, and a center of a magnetic flux vector emanating from the sensing magnet is aligned with a D-axis of the rotor.
